(19) United States
(12) Patent Application Publication
(10) Pub. No.: US 2009/0179885 A1
(43) Pub. Date: Jul. 16, 2009

(54) PLASMA DISPLAY AND DRIVING METHOD THEREOF

(76) Inventor: Jae-Young Yeo, Suwon-si (KR)

Correspondence Address: CHRISTIE, PARKER & HALE, LLP, PO BOX 7068, PASADENA, CA, 91109-7068, US

(21) Appl. No.: 12/351,481

(22) Filed: Jan. 9, 2009

(30) Foreign Application Priority Data
Jan. 15, 2008 (KR) 10-2008-0004409

(51) Int. Cl. G06F 3/038

(52) U.S. Cl. 345/211

(57) ABSTRACT

A plasma display device is configured to apply a scan pulse to a scan electrode in a first subfield, apply a plurality of sequentially delayed address pulses to a plurality of address electrodes crossing the scan electrode. In addition, a plasma display device is configured to apply a plurality of address pulses to the plurality of address electrodes at the same time in a second subfield that has a weight value that is less than a weight value of the first subfield. Thereby, electromagnetic interference (EMI) can be reduced in the first subfield where a substantial amount of EMI is generated, and a low discharge can be reduced in the second subfield that has a high probability of the low discharge being generated.

### CROSS-REFERENCE TO RELATED APPLICATION

This application claims priority to and the benefit of Korean Patent Application No. 10-2008-0004409, filed in the Korean Intellectual Property Office on Jan. 15, 2008, the entire content of which is incorporated herein by reference.

### BACKGROUND OF THE INVENTION

1. Field of the Invention

The present invention relates to a plasma display device and driving method thereof.

2. Description of the Related Art

A plasma display device is a display device that uses a plasma display panel (PDP) for displaying characters or images by using plasma generated by gas discharge.

The plasma display device is driven with a frame divided into a plurality of subfields each having a luminance weight value, and displays gray levels by a combination of weight values of subfields. Thus, a display operation is performed by using a combination of the plurality of subfields. During an address period of each of the subfields, a scan pulse is sequentially applied to a plurality of scan electrodes, and address pulses are selectively applied to a plurality of address electrodes when the scan pulse is applied to a scan electrode so that light emitting cells or non-light emitting cells are selected. An address discharge occurs in a cell corresponding to the scan electrode that is applied with the scan pulse and the address electrode that is applied with the address pulse.

When a large number of light emitting cells are selected as the scan pulse is applied to one scan electrode, the address pulses are applied to a number of address electrodes corresponding to the light emitting cells. Therefore a discharge current is increased, and more electromagnetic interference (EMI) is generated. Thus, to disperse the discharge current and reduce EMI, the address pulses are applied to the address electrodes corresponding to the light emitting cells at a different point of time. However, a low discharge may occur in cells in which the address pulses are applied later in time. Particularly, there is an increased probability that a low discharge occurs in a low gray level subfield in which wall charges are not sufficiently formed.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Exemplary embodiments of the present invention provide a plasma display that can reduce a low discharge when address pulses are applied to the address electrodes of the light emitting cells at different points of time, and a driving method thereof.

One exemplary embodiment of the present invention discloses a method for driving a plasma display with one frame divided into a plurality of subfields, the plasma display including a plurality of scan electrodes and a plurality of address electrodes crossing the plurality of scan electrodes. According to the method, a first scan pulse is applied to a scan electrode among the plurality of scan electrodes in a first subfield among the plurality of subfields, a second address pulse is applied to a second address electrode among the plurality of address electrodes after a first address pulse is applied to a first address electrode among the plurality of address electrodes while the first scan pulse is being applied to the first scan electrode in the first subfield, a second scan pulse is applied to the scan electrode in a second subfield among the plurality of subfields, the second subfield having a weight value that is lower than a weight value of the first subfield, and third and fourth address pulses are concurrently applied to the first and second address electrodes, respectively, while the second scan pulse is being applied to the scan electrode in the second subfield.

Another exemplary embodiment of the present invention discloses a method for driving a plasma display including a plurality of cells at crossing regions between a plurality of scan lines and a plurality of address electrodes. According to the method, a first scan pulse is applied to a scan line among the plurality of scan line in a first subfield, a plurality of sequentially delayed address pulses are applied to the plurality of cells, while the first scan pulse is being applied to the scan line, a second scan pulse is applied to the scan line in a second subfield having a weight value that is lower than a weight value of the first subfield, and a plurality of address pulses are concurrently applied to the plurality of cells while the second scan pulse is being applied to the scan line.

Still another exemplary embodiment of the present invention provides a plasma display including a plurality of scan electrodes, a plurality of address electrodes, a first driver, a second driver, and a controller. The plurality of address electrodes cross the plurality of scan electrodes. The first driver is configured to apply a scan pulse to a scan electrode among the plurality of scan electrodes, and the second driver is configured to apply a plurality of address pulses to the plurality of address electrodes while the scan pulse is being applied to the scan electrode. The controller sets starting points of the plurality of address pulses to be different in each subfield of a first group among a plurality of subfields included in one frame, and sets starting points of the plurality of address pulses to be the same in each subfield of a second group among the plurality of subfields. The second group has weight values that are less than weight values of the first group.

According to exemplary embodiments of the present invention, since address pulses are applied to the A electrodes corresponding to a plurality of light emitting cells coupled to one scan line at different times in a high gray level subfield, and address pulses are applied to the A electrodes corresponding to a plurality of light emitting cells coupled to one scan line at the same time in a low gray level subfield, the EMI and the low discharge may be reduced.

### BRIEF DESCRIPTION OF THE DRAWINGS

FIG. 1 is a block diagram showing a plasma display device according to an exemplary embodiment of the present invention.

FIG. 2 is a drawing showing a driving waveform according to an exemplary embodiment of the present invention.

FIG. 3 is a timing diagram for applying address pulses according to an exemplary embodiment of the present invention.

FIG. 4 is a drawing showing an operation of an address electrode driver according to an exemplary embodiment of the present invention.

### DETAILED DESCRIPTION OF EXEMPLARY EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, if something is described to “include constituent elements”, it may further include other constituent elements unless it is described that is does not include other constituent elements.

In the present application, a wall charge refers to a charge formed on the wall of a cell and being close to each electrode, for example, on a dielectric layer. Although the wall charges do not actually touch the electrodes, the wall charges will be described as being “formed” or “accumulated” on the electrodes for the convenience of description. Also, a wall voltage refers to a potential difference formed at the wall of a cell by wall charges. A weak discharge refers to a discharge that is weaker than a sustain discharge in a sustain period and an address discharge in an address period.

The plasma display device and driving method thereof according to an exemplary embodiment of the present invention will now be described in detail.

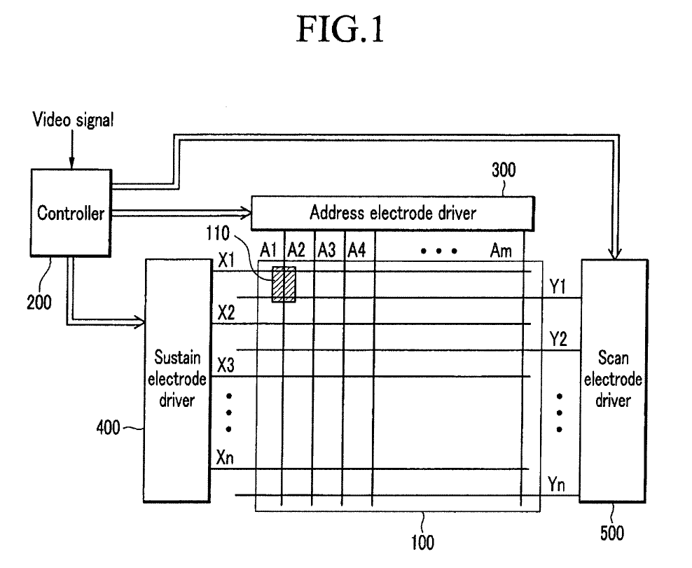

FIG. 1 is a block diagram showing a plasma display device according to an exemplary embodiment of the present invention.

As shown in FIG. 1, a plasma display device according to an exemplary embodiment of the present invention includes a plasma display panel 100, a controller 200, an address electrode driver 300, a sustain electrode driver 400, and a scan electrode driver 500.

The plasma display panel 100 includes a plurality of address electrodes A1˜Am (referred to as “A electrodes” hereinafter) extending in a column direction, and a plurality of sustain electrodes X1˜Xn (referred to as “X electrodes” hereinafter) and a plurality of scan electrodes Y1˜Y (referred to as “Y electrodes” hereinafter) extending in a row direction, in pairs. In general, the X electrodes X1˜Xn are formed to correspond to the respective Y electrodes Y1˜Y, and the X electrodes X1˜Xn and the Y electrodes Y1˜Y perform a display operation during a sustain period in order to display an image. The Y electrodes Y1˜Y and the X electrodes X1˜Xn are disposed to cross the A electrodes A1˜Am. A plurality of scan lines are defined by the Y electrodes Y1˜Yn applied with a scan pulse during an address period, and address lines are defined by the A electrodes A1˜Am applied with address pulses. In addition, discharge spaces present at crossing areas of the A electrodes A1˜Am and the X and Y electrodes X1˜Xn and Y1˜Y form discharge cells 110. The structure of the PDP 100 shows an exemplary PDP, and a panel with a different structure to which driving waveforms described herein can be applied can also be applicable in the present invention.

The controller 200 receives a video signal from the outside and outputs an A electrode driving control signal, an X electrode driving control signal, and a Y electrode driving control signal. Further, the controller 200 drives a frame by dividing the frame into a plurality of subfields each having a weight value. Each subfield includes the address period and a sustain period.

The address electrode driver 300 receives the A electrode driving control signal from the controller 200 and applies a driving voltage to the A electrodes.

The sustain electrode driver 400 receives the X electrode driving control signal from the controller 200 and applies a driving voltage to the X electrodes.

The scan electrode driver 500 receives the Y electrode driving control signal from the controller 200 and applies a driving voltage to the Y electrodes.

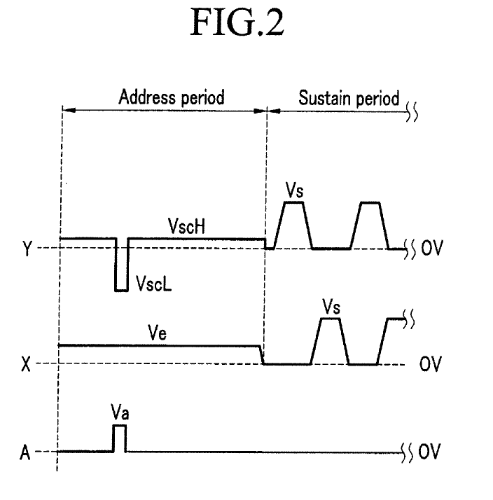

FIG. 2 is a drawing showing a driving waveform according to an exemplary embodiment of the present invention.

As shown in FIG. 2, during an address period, in order to select a light emitting cell and a non-light emitting cell among the plurality of discharge cells in each subfield, the sustain electrode driver 400 maintains a voltage of the X electrode at a voltage Ve, and the scan electrode driver 500 and the address electrode driver 300 apply a scan pulse having a voltage VscL and an address pulse having a voltage Va to the Y electrode and the A electrode, respectively. Further, the scan electrode driver 500 applies a voltage VscH that is higher than the voltage VscL to a non-selected Y electrode, and the address electrode driver 300 applies a ground voltage to the A electrode of a non-light emitting cell.

In detail, in the address period, the scan electrode driver 500 applies a scan pulse to the Y electrode (Y1 in FIG. 1) of a first row, and, at the same time, the address electrode driver 300 applies address pulses to the A electrodes corresponding to light emitting cells in the first row. Then, address discharges occur between the Y electrode (Y1 in FIG. 1) of the first row and the A electrodes to which the address pulses have been applied, thereby forming positive (+) wall charges on the Y electrode (Y1 in FIG. 1) and negative (−) wall charges on the A and X electrodes. Subsequently, while the scan electrode driver 500 applies a scan pulse to the Y electrode (Y2 in FIG. 1) of a second row, the address electrode driver 300 applies address pulses to the A electrodes corresponding to light emitting cells of the second row. Then, address discharges occur at cells formed by the A electrodes to which the address pulses have been applied and the Y electrode (Y2 in FIG. 1) of the second row, thereby forming wall charges in the cells. Likewise, while the scan electrode driver 500 sequentially applies scan pulses to the Y electrodes of the remaining rows, the address electrode driver 300 applies address pulses to the A electrodes corresponding to light emitting cells to form wall charges therein.

In the sustain period, the scan electrode driver 500 applies a sustain pulse having a high level voltage (Vs in FIG. 2) and a low level voltage (0V in FIG. 2) to the Y electrodes for a number of times corresponding to a weight value of the corresponding subfield. In addition, the sustain electrode driver 400 applies a sustain pulse to the X electrodes in a phase opposite to that of the sustain pulse applied to the Y electrodes. That is, 0V is applied to the X electrode when a Vs voltage is applied to the Y electrode, and the Vs voltage is applied to the X electrode when 0V is applied to the Y electrode. In this case, the voltage difference between the Y electrode and the X electrode alternately has a Vs voltage and a −Vs voltage. Accordingly, the sustain discharge repeatedly occurs at light emitting cells for a number of times according to the weight value of a subfield.

In another embodiment, during the sustain period, a sustain pulse alternately having a Vs voltage and a −Vs voltage is applied to only the Y electrodes or the X electrodes, and a voltage of 0V may be applied to the other electrodes of the Y electrodes or the X electrodes. In this embodiment, since the voltage difference between the Y electrode and the X electrode also alternately has a Vs voltage and a −Vs voltage, the sustain discharge occurs at the light emitting cells.

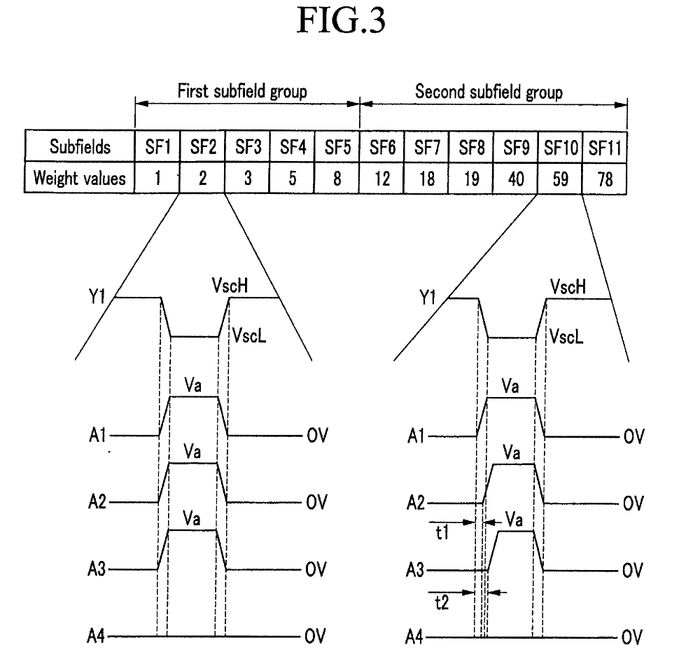

Next, a timing for applying address pulses to the A electrodes corresponding to the light emitting cells while the scan pulse is applied to one scan electrode will be described in detail with reference to FIG. 3.

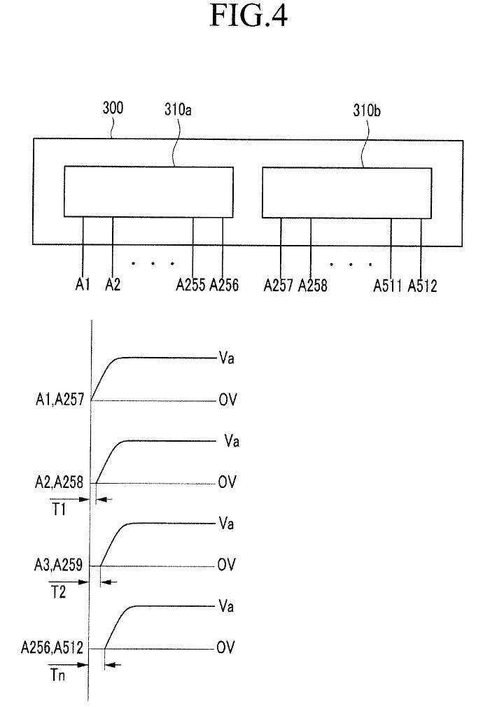

FIG. 3 illustrates a timing for applying address pulses according to an exemplary embodiment of the present invention, and FIG. 4 illustrates an operation of an address electrode driver according to an exemplary embodiment of the present invention.

As shown in FIG. 3, one frame includes 11 subfields SF1-SF11 respectively having weight values 1, 2, 3, 5, 8, 12, 18, 19, 40, 59, and 78; and gray levels may be displayed from the gray level 0 to the gray level 255. Further, FIG. 3 shows only one scan electrode Y1 and four A electrodes A1-A4 for better understanding and ease of description. In addition, FIG. 3 shows that the address pulses are applied to the A electrodes A1-A3, and an address pulse is not applied to the A electrode A4 while the scan pulse is applied to the scan electrode Y1.

Again, referring to FIG. 3, a plurality of subfields is divided into two subfield groups according to weight values. The address electrode driver 300 applies the address pulses to the A electrodes A1-A3 at the same time while the scan pulse is applied to the scan electrode Y1 in each address period of a first subfield group having low weight value. In addition, the address electrode driver 300 applies the address pulses to the A electrodes A1-A3 at different times while the scan pulse is applied to the scan electrode Y1 in each address period of a second subfield group having a high weight value (e.g., higher weight value than the first subfield group).

In detail, in each address period of the second subfield group, while the scan pulse is applied to the Y electrode Y1, the address electrode driver 300 changes a voltage of the A electrode A1 from the voltage 0V to the voltage Va, and changes a voltage of the A electrode A2 from the voltage 0V to the voltage Va after a time interval t1 (e.g., a predetermined time interval) that starts from a starting point at which the voltage of the Y electrode Y1 is changed from the voltage VscH to the voltage VscL. Further, the address electrode driver 300 changes a voltage of the A electrode A3 from the voltage 0V to the voltage Va after a time interval t2 (e.g., a predetermined time interval) that starts from a starting point at which the voltage of the Y electrode Y1 is changed from the voltage VscH to the voltage VscL. In addition, the address electrode driver 300 changes the voltage of the A electrodes A1-A3 from the voltage Va to the voltage 0V at the same time.

In general, since the number of sustain pulses in each subfield of the first subfield group is less than the number of sustain pulses in each subfield of the second subfield group, wall charges are not sufficiently formed in the cells. Thus, when the A electrodes A1-A3 are applied with the address pulses at different times, a low discharge may occur between the scan electrode Y1 and the A electrode A3 that is applied with the address pulse later than the A electrodes A1 and A2.

However, since the number of sustain pulses applied in each subfield of the second subfield group having a high weight value is greater than the number of sustain pulses applied in each subfield of the first subfield group, wall charges are sufficiently formed in the cells. Thus, even when the A electrodes A1-A3 are applied with the address pulses at different times, there is a reduced probability that low discharge will occur between the scan electrode Y1 and the A electrode A3 that is applied with a delayed address pulse in each address period of each subfield of the second subfield group.

In addition, when the address pulses are applied to the A electrodes A1-A3 at the same time in each address period of each subfield of the second subfield group, wall charges are formed in the cells, and a large amount of EMI may be generated by a large discharge current. However, even if the address pulses are applied to the A electrodes A1-A3 at the same time in each address period of each subfield of the first subfield group, the EMI may not be generated.

Thus, according to an exemplary embodiment of the present invention, the address pulses are applied to the A electrodes A1-A3 at the same time in each address period of each subfield of the first subfield group having a low weight value, and the address pulses are applied to the A electrodes A1-A3 at different times in each address period of each subfield of the second subfield group having a high weight value. Then, the EMI and the low discharge problems may be resolved or reduced.

As shown in FIG. 4, the address electrode driver 300 includes a plurality of address driving integrated circuits 310a and 310b, and the plurality of address driving integrated circuits 310a and 310b have a plurality of output terminals, respectively. The plurality of output terminals of the address driving integrated circuits 310a and 310b are respectively connected with the A electrodes A1-Am corresponding to the number of output terminals. For example, the output terminals of the address driving integrated circuit 310a may be respectively coupled with the A electrodes A1-A256, and the output terminals of the address driving integrated circuit 310b may be respectively coupled with the A electrodes A257-A510.

The address driving integrated circuits 310a and 310b apply sequentially delayed address pulses to the plurality of address electrodes A1-Am coupled to the plurality of output terminals. In the embodiment shown FIG. 4, the plurality of output terminals of the address driving integrated circuit 310a are respectively coupled to the A electrodes A1-A256, and the plurality of output terminals of the address driving integrated circuit 310b are respectively coupled to the A electrodes A257-A512. The address pulses are applied to the A electrodes A1-A512 as follows: the address driving integrated circuits 310a and 310b begin to apply the address pulses to the A electrodes A1 and A257, begin to apply the address pulses to the A electrodes A2 and A258 after a time interval T1 (e.g., a predetermined time interval), and begin to apply the address pulses to the A electrodes A3 and A259 after a time interval T2 (e.g., a predetermined time).

This sequence continues through the remaining address electrodes A4 to A255 and A260 to A511 until the address driving integrated circuits 310a and 310b begin to apply the address pulses to the A electrode A256 and A512 after a time interval Tn (e.g., a predetermined time interval).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display with one frame divided into a plurality of subfields, the plasma display comprising a plurality of scan electrodes and a plurality of address electrodes crossing the plurality of scan electrodes, the method comprising:
applying a first scan pulse to a scan electrode among the plurality of scan electrodes in a first subfield among the plurality of subfields;
applying a second address pulse to a second address electrode among the plurality of address electrodes after a first address pulse is applied to a first address electrode among the plurality of address electrodes while the first scan pulse is being applied to the scan electrode in the first subfield;
applying a second scan pulse to the scan electrode in a second subfield among the plurality of subfields, the second subfield having a weight value that is lower than a weight value of the first subfield; and
concurrently applying a third address pulse and a fourth address pulse to the first address electrode and second address electrode, respectively, while the second scan pulse is being applied to the scan electrode in the second subfield.

2. The method of claim 1, wherein a starting point of the second address pulse is later than a starting point of the first address pulse, and a starting point of the third address pulse is the same as a starting point of the fourth address pulse.

3. The method of claim 1, wherein a finishing point of the first address pulse is the same as a finishing point of the second address pulse, and a finishing point of the third address pulse is the same as a finishing point of the fourth address pulse.

4. The method of claim 1, wherein the first and second address pulses each have a high level voltage and a low level voltage, and the applying of the second address pulse in the first subfield comprises:
changing a voltage of the second address electrode from the low level voltage to the high level voltage after a voltage of the first address electrode is changed from the low level voltage to the high level voltage;
maintaining the voltages of the first and second address electrodes at the high level voltage; and
concurrently changing the voltages of the first and second address electrodes from the high level voltage to the low level voltage.

5. A method for driving a plasma display comprising a plurality of cells at crossing regions between a plurality of scan lines and a plurality of address electrodes, the method comprising:
applying a first scan pulse to a scan line among the plurality of scan lines in a first subfield;
applying a plurality of sequentially delayed address pulses to the plurality of cells while the first scan pulse is being applied to the scan line;
applying a second scan pulse to the scan line in a second subfield having a weight value that is lower than a weight value of the first subfield; and
concurrently applying a plurality of address pulses to the plurality of cells while the second scan pulse is being applied to the scan line.

6. The method of claim 5, wherein in the first subfield, the plurality of sequentially delayed address pulses are outputted after being delayed by an address driving circuit that outputs the plurality of sequentially delayed address pulses.

7. The method of claim 6, wherein in the first subfield, finishing points of the plurality of sequentially delayed address pulses are the same.

8. A plasma display comprising:
a plurality of scan electrodes;
a plurality of address electrodes crossing the plurality of scan electrodes;
a first driver for applying a scan pulse to a scan electrode among the plurality of scan electrodes;
a second driver for applying a plurality of address pulses to the plurality of address electrodes while the scan pulse is being applied to the scan electrode; and
a controller for setting starting points of the plurality of address pulses to be different in each subfield of a first group among a plurality of subfields included in one frame, and for setting starting points of the plurality of address pulses to be the same in each subfield of a second group among the plurality of subfields, the second group having weight values that are less than weight values of the first group.

9. The plasma display of claim 8, wherein the second driver comprises an address driving integrated circuit having a plurality of output terminals coupled with the plurality of address electrodes, the address driving integrated circuit controlled by the controller,
wherein the address driving integrated circuit is configured to output the plurality of address pulses in an order of increasingly delayed start time in each subfield of the first group, and outputs the plurality of address pulses at the same time in each subfield of the second group.

10. The plasma display of claim 8, wherein the controller sets finishing points of the plurality of address pulses to be the same in each subfield of the first and second groups.
